(19) United States
(12) Patent Application Publication
(10) Pub. No.: US 2008/0026355 A1
(43) Pub. Date: Jan. 31, 2008

(54) SONG LYRICS DOWNLOAD FOR KARAOKE APPLICATIONS

(75) Inventor: Andrej Petef, Malmo (SE)

Correspondence Address: HARRITY SNYDER, L.L.P., 11350 RANDOM HILLS ROAD, SUITE 600, FAIRFAX, VA, 22030, US

(73) Assignee: SONY ERICSSON MOBILE COMMUNICATIONS AB, Lund (SE)

(21) Appl. No.: 11/460,502

(22) Filed: Jul. 27, 2006

(51) Int. Cl. G09B 5/00

(52) U.S. Cl. 434/307 A

(57) ABSTRACT

A method performed by a mobile terminal may include connecting to a network, selecting song lyrics to be downloaded to a mobile terminal, storing the downloaded song lyrics in the mobile terminal; and simultaneously playing a stored song while displaying the downloaded song lyrics on the mobile terminal. A method may also include downloading and displaying lyrics in synchronization with received real-time music.

### TECHNICAL FIELD OF THE INVENTION

The systems and methods described herein generally relate to communications devices and, more particularly, to Karaoke applications for portable communications devices.

### DESCRIPTION OF RELATED ART

Communication devices, such as cellular telephones, have become increasingly versatile. For example, cellular telephones often include music features that enable users to obtain and play songs. At the present time, the music features employed on cellular telephones and portable communications devices may display song lyrics while simultaneously playing a song, thereby enabling a Karaoke feature, only if the words and music have been pre-stored together in the appropriate manner. At the present time, there is not an adequate solution that will allow a communication device to display lyrics while playing songs, if the lyrics have not been previously pre-stored with the song in the communication device.

### SUMMARY

According to one aspect, a method performed by a mobile terminal comprises selecting a song for which song lyrics are desired, obtaining the song lyrics from a server, storing the song lyrics, and simultaneously playing the song while displaying the song lyrics on the mobile terminal.

Additionally, the storing the song lyrics further comprises, associating and storing the song lyrics with the song.

Additionally, the associating and storing the song lyrics with the song further comprises associating and storing the song lyrics in a timed text format with the song.

Additionally, the obtaining the song lyrics from a server includes downloading the song lyrics from the server.

Additionally, the selecting a song for which lyrics are desired includes selecting the song from a displayed list of songs stored in the mobile terminal.

According to another aspect, a mobile terminal is provided. The mobile terminal comprises a speaker for outputting music, a memory for storing audio files corresponding to a plurality of songs, a display, and logic configured to select a song for which song lyrics are desired, obtain the song lyrics, and associate and store in the memory the song lyrics with the song data stored in the memory.

Additionally, the logic may be configured to control the display to simultaneously display the song lyrics while outputting the song music data through the speaker.

Additionally, the song lyrics are in a timed text compatible format.

Additionally, the logic is further configured to control the display to present a list of songs stored in the memory in the mobile terminal.

Additionally, the song lyrics are downloaded from a network to the mobile terminal.

According to another aspect, a method is provided. The method comprises receiving real-time music, selecting to download song lyrics associated with the received real-time music; downloading the selected song lyrics associated with received real-time music to a mobile terminal, and displaying the downloaded song lyrics associated with the received real-time music substantially in synchronization with the received real-time music.

Additionally, the selecting to download song lyrics associated with the received real-time music further comprises transmitting the received real-time music to a server.

Additionally, the method further comprises prompting a user to save the downloaded song lyrics associated with the received real-time music.

Additionally, the method further comprises saving the downloaded song lyrics associated with the received real-time music in a memory in the mobile terminal.

Additionally, the server identifies a song associated with the transmitted real-time music.

According to another aspect, a mobile terminal is provided. The mobile terminal comprises a display, and logic configured to obtain song lyrics associated with real-time music, and control the display to display the song lyrics substantially in synchronization with the real-time music.

Additionally, the logic is further configured to prompt a user to save the song lyrics associated with the real-time music.

Additionally, the mobile terminal comprises a microphone for transmitting the real-time music to a server.

Additionally, the server identifies a song associated with the real-time music.

Additionally, the song lyrics associated with the received real-time music are downloaded from the server.

Other features and advantages of the systems and methods described herein will become readily apparent to those skilled in this art from the following detailed description. The implementations shown and described provide illustration of the best mode contemplated for carrying out the embodiments. Accordingly, the drawings are to be regarded as illustrative in nature, and not as restrictive.

### BRIEF DESCRIPTION OF THE DRAWINGS

Reference is made to the attached drawings, wherein elements having the same reference number designation may represent like elements throughout.

FIG. 1 is a diagram of an exemplary system in which methods and systems described herein may be implemented;

FIG. 2 is a diagram of an exemplary server shown in FIG. 1;

FIG. 3 is a diagram of an exemplary mobile terminal as shown in FIG. 1;

FIGS. 4A-4B show exemplary displays on a mobile terminal;

FIG. 5 is a flow diagram illustrating exemplary processing by a mobile terminal; and

FIG. 6 is a flow diagram illustrating exemplary processing by a mobile terminal.

### DETAILED DESCRIPTION

The following detailed description refers to the accompanying drawings. The same reference numbers in different drawings identify the same or similar elements. Also, the following detailed description does not limit the systems and methods described herein. Instead, the scope of the systems and methods are defined by the appended claims and equivalents.

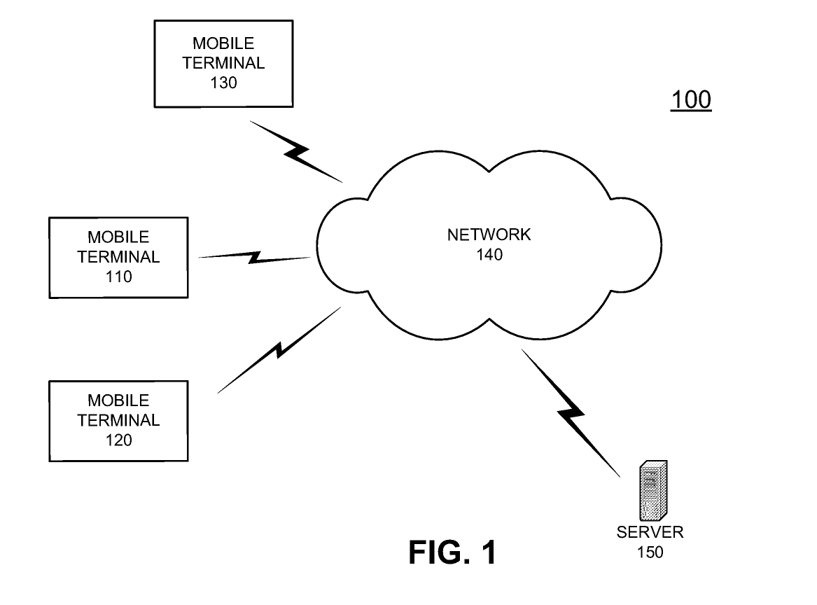

FIG. 1 is a diagram of an exemplary system 100 in which methods and systems described herein may be implemented. System 100 may include mobile terminals 110, 120 and 130, and server 150, connected via network 140. It should be understood that system 100 may include other numbers of mobile terminals and servers.

The methods and systems described herein may be implemented in the context of a mobile terminal. As used herein, the term “mobile terminal” may include a cellular radiotelephone; a Personal Communications System (PCS) terminal that may combine a cellular radiotelephone with data processing, facsimile and data communications capabilities; a personal digital assistant (PDA) that can include a radiotelephone, pager, Internet/Intranet access, Web browser, organizer, calendar and/or a global positioning system (GPS) receiver, a radio (AM/FM) receiver; and a laptop and/or palmtop receiver or other appliance that includes a radiotelephone transceiver. Mobile terminals may also be referred to as “pervasive computing” devices that are capable of communicating with other devices via SMS protocols or other protocols that allow for simultaneous communications of voice, data, music and video information.

Network 140 may include one or more networks, such as a cellular network, a satellite network, the Internet, a telephone network, such as the Public Switched Telephone Network (PSTN), a metropolitan area network (MAN), a wide area network (WAN), a local area network (LAN), or a combination of networks. Mobile terminals 110, 120 and 130 may communicate with each other over network 140 via wired, wireless or optical connections.

In an exemplary implementation, network 140 includes a cellular network used for transmitting data between mobile terminals 110-130 and server 150. For example, components of a cellular network may include base station antennas (not shown) that transmit and receive data from mobile terminals within their vicinity. Other components of a cellular network, for example, may also include base stations (not shown) that connect to the base station antennas and communicate with other devices, such as switches and routers (not shown) in accordance with known techniques.

Server 150 may include one or more processors or microprocessors enabled by software programs to perform functions, such as data storage and transmission, codex conversion, and interfacing with other servers (not shown) and mobile terminals 110-130, for example. Server 150 may also include a data storage memory such as a random access memory (RAM) or another dynamic storage device that stores information such as lyrics information, as described in detail below.

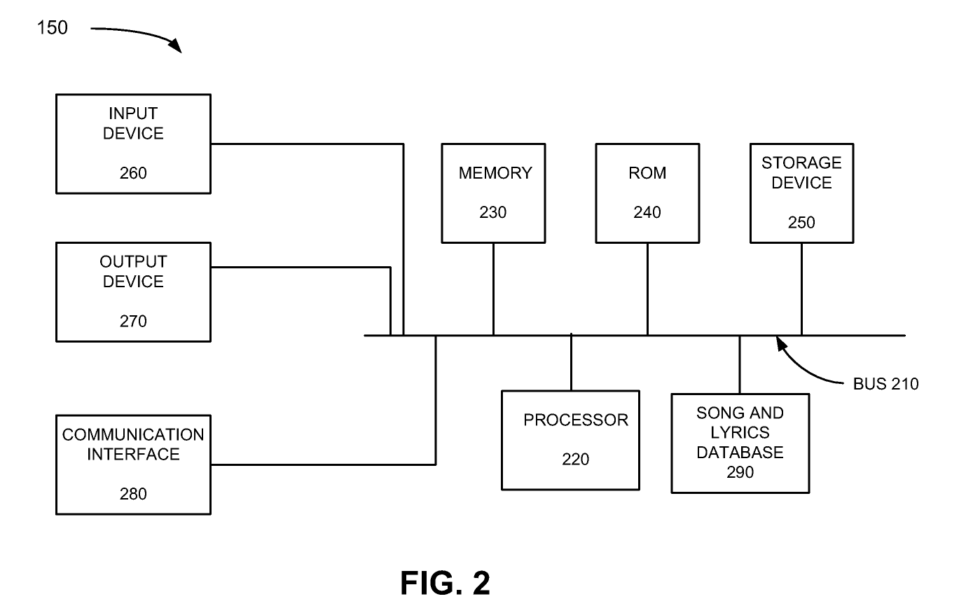

FIG. 2 is a diagram of an exemplary configuration of server 150. Server 150 may include bus 210, processor 220, a memory 230, a read only memory (ROM) 240, a storage device 250, an input device 260, an output device 270, a communication interface 280, and a song and lyrics database 290. Server 150 may also include one or more power supplies (not shown). One skilled in the art would recognize that server 150 may be configured in a number of other ways and may include other or different elements.

Bus 210 permits communication among the components of server 150. Processor 220 may include any type of processor, microprocessor, or processing logic that may interpret and execute instructions. Processor 220 may also include logic that is able to decode media files, such as audio files, video files, etc., and generate output to, for example, a speaker, a display, etc. Memory 230 may include a random access memory (RAM) or another dynamic storage device that stores information and instructions for execution by processor 220. Memory 230 may also be used to store temporary variables or other intermediate information during execution of instructions by processor 220.

ROM 240 may include a ROM device and/or another static storage device that stores static information and instructions for processor 220. Storage device 250 may include a magnetic disk or optical disk and its corresponding drive and/or some other type of magnetic or optical recording medium and its corresponding drive for storing information and instructions. Storage device 250 may also include a flash memory (e.g., an electrically erasable programmable read only memory (EEPROM)) device for storing information and instructions.

Input device 260 may include one or more mechanisms that permit a user to input information to server 150, such as a keyboard, a mouse, a microphone, a pen, voice recognition and/or biometric mechanisms, etc. Output device 270 may include one or more mechanisms that output information to the user, including a display, a printer, a speaker, etc.

Communication interface 280 may include any transceiver-like mechanism that enables server 150 to communicate with other devices and/or systems. For example, communication interface 280 may include a modem or an Ethernet interface to a LAN. In addition, communication interface 280 may include other mechanisms for communicating via a network, such as a wireless network. For example, communication interface 280 may include one or more radio frequency (RF) transmitters, and one or more receivers and antennas for transmitting and receiving (RF) signals. Communication interface 280 may also include transmitters/receivers for communicating with mobile terminals 110-130. Communication interface 280 may also include, for example, transmitters/receivers configured to transmit/receive SMS protocol signals.

Song and lyrics database 290 may contain for example, song audio data (e.g. song/music files) and associated song lyrics information. For example, songs may be stored as audio files in MPEG4/3GPP format for example, and song lyrics information may be stored in a timed text format. Song and lyrics database 290 may also perform processing for identifying a music file based on audio data associated with the music, determining a real-time point in the identified music file, and for associating song lyrics with the identified music file. Song and lyrics database 290 may store songs with lyrics inserted in the audio file, or may store the lyrics separately from the audio file, for example.

According to an exemplary implementation, server 150 may perform various processes in response to processor 220 executing sequences of instructions contained in memory 230. Such instructions may be read into memory 230 from another computer-readable medium, such as storage device 250, or from a separate device via communication interface 280. It should be understood that a computer-readable medium may include one or more memory devices or carrier waves. Execution of the sequences of instructions contained in memory 230 causes processor 220 to perform the acts that will be described hereafter. In alternative embodiments, hardwired circuitry may be used in place of or in combination with software instructions to implement aspects of the embodiments. Thus, the systems and methods described herein are not limited to any specific combination of hardware circuitry and software.

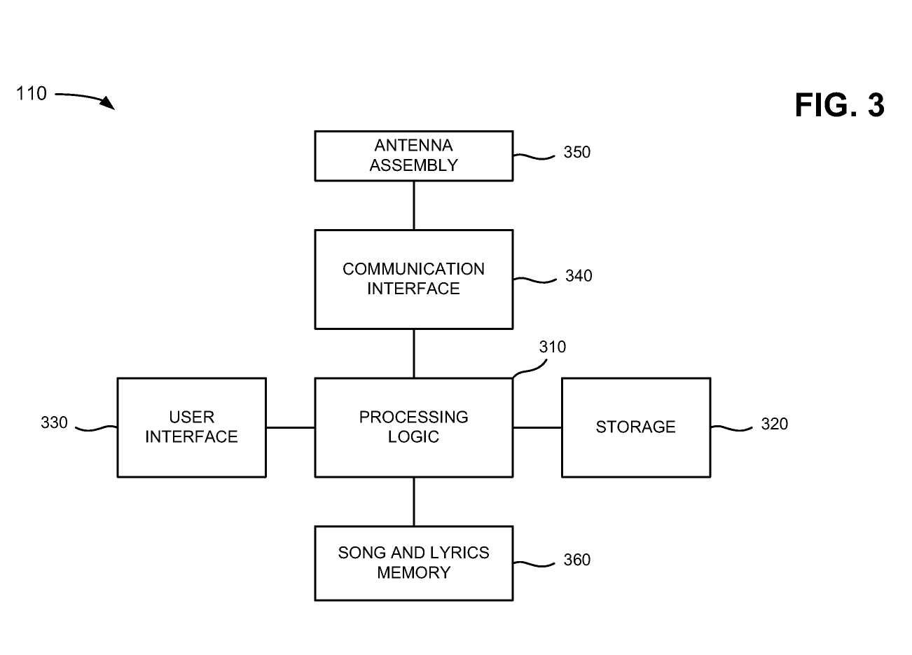

FIG. 3 is a diagram of exemplary components of mobile terminal 110. As shown in FIG. 3, mobile terminal 110 may include processing logic 310, storage 320, user interface 330, communication interface 340, and antenna assembly 350, and song and lyrics memory 360. Processing logic 310 may include a processor, a microprocessor, an application specific integrated circuit (ASIC), a field programmable gate array (FPGA), or the like. Processing logic 310 may include data structures or software programs to control operation of mobile terminal 110 and its components. Storage 320 may include a random access memory (RAM), a read only memory (ROM), and/or another type of memory to store data and instructions that may be used by processing logic 3 10.

User interface 330 may include mechanisms for inputting information and/or music to mobile terminal 110 and/or for outputting information and/or music from mobile terminal 110. Examples of input and output mechanisms might include a speaker to receive electrical signals and output audio signals, a microphone to receive audio signals and output electrical signals, an audio input jack for receiving music from an external source, control buttons and/or keys on a keypad to permit data and control commands to be input into mobile terminal 110, and a display to output visual information. User interface 330 may also include an FM radio chip that may allow mobile terminal 110 to receive and process FM radio signals that may be output through a speaker. Real-time music received through an audio input jack or the FM radio chip for example, may be further processed by a digital audio interface contained within user interface 330. These exemplary types of input and output mechanisms and interfaces contained in user interface 330 are shown and described in greater detail below.

Communication interface 340 may include, for example, a transmitter that may convert baseband signals from processing logic 310 to radio frequency (RF) signals and/or a receiver that may convert RF signals to baseband signals. Alternatively, communication interface 340 may include a transceiver to perform functions of both a transmitter and a receiver. Communication interface 340 may connect to antenna assembly 350 for transmission and reception of the RF signals. Antenna assembly 350 may include one or more antennas to transmit and receive RF signals over the air. Antenna assembly 350 may receive RF signals from communication interface 340 and transmit them over the air and receive RF signals over the air and provide them to communication interface 340.

Song and lyrics memory 360 may contain stored music data and lyrics data. For example, memory 360 may contain audio music files stored in an MPEG4/3GPP format. For example, memory 360 also may perform certain operations relating to receiving downloaded lyrics in a timed text format, and then associating, inserting, and storing the downloaded lyrics with the song. In different implementations, the downloaded lyrics may be stored separately (in memory 360) from the song, or stored in the audio file with the song, in song and lyric memory 360.

As will be described in detail below, mobile terminal 110 may perform these operations in response to processing logic 310 executing software instructions contained in a computer-readable medium, such as storage 320.

The software instructions may be read into storage 320 from another computer-readable medium or from another device via communication interface 340. The software instructions contained in storage 320 may cause processing logic 310 to perform processes that will be described later. Alternatively, hardwired circuitry may be used in place of or in combination with software instructions to implement processes consistent with the embodiments. Thus, implementations consistent with the principles of the embodiments are not limited to any specific combination of hardware circuitry and software.

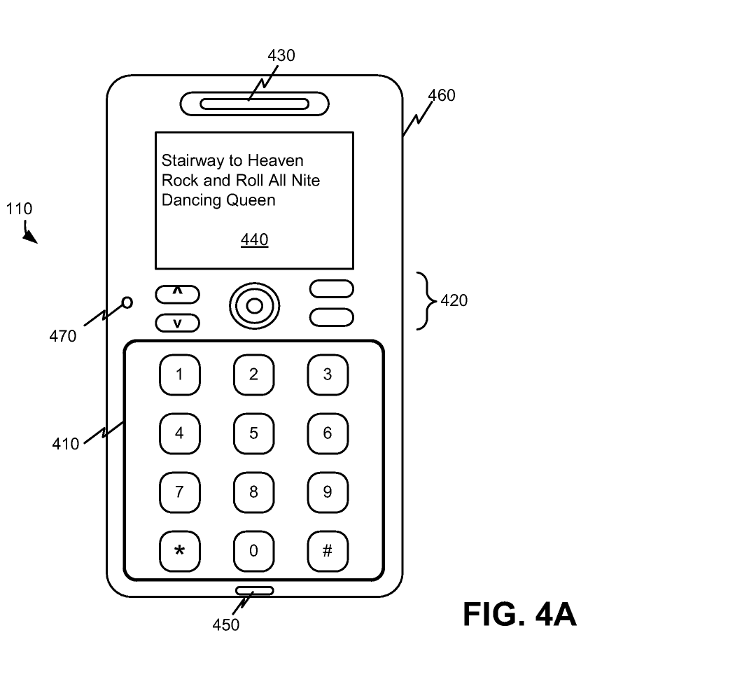

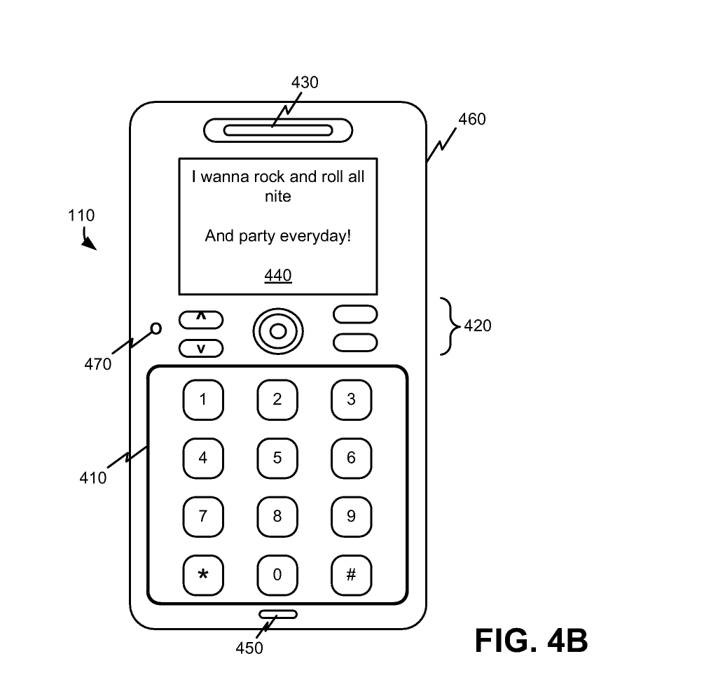

FIG. 4A shows an exemplary mobile terminal 110 that may include housing 460, keypad 410, control keys 420, speaker 430, display 440, and microphone 450. Housing 460 may include a structure configured to hold components used in mobile terminal 110. Housing 460 may be formed from plastic, metal, or composite and may be configured to support keypad 410, control keys 420, speaker 430, display 440, microphone 450 and audio input jack 470.

Keypad 410 may include keys that can be used to operate mobile terminal 110. Keypad 410 may further be adapted to receive user inputs, directly or via other devices, such as a stylus for entering information into mobile terminal 110. In one implementation, communication functions of mobile terminal 110 may be controlled by activating keys in keypad 410. Implementations of keys may have key information associated therewith, such as numbers, letters, symbols, etc. The user may operate keys in keypad 410 to place calls, enter digits, commands, and text messages, into mobile terminal 110. Designated functions of keys may form and/or manipulate images that may be displayed on display 440.

Control keys 420 may include buttons that permit a user to interact with mobile terminal 110 to perform specified actions, such as to interact with display 440, etc. For example, a user may use control keys 420 to scroll through a list of stored songs and select a song for lyrics to be downloaded from server 150.

Speaker 430 may include a device that provides audible information to a user of mobile terminal 110. Speaker 430 may be located anywhere on mobile terminal 110 and may function, for example, as an earpiece when a user communicates using mobile terminal 110. Speaker 430 may also function as an output device for playing music (e.g., stored audio files of songs contained in song and lyrics memory 360).

Display 440 may include a device that provides visual images to a user. For example, display 440 may provide song lyrics to a user. Display may also display graphic information regarding incoming/outgoing calls, text messages, games, phonebooks, the current date/time, volume settings, etc., to a user of mobile terminal 110. Implementations of display 440 may be implemented as black and white or color flat panel displays.

FIG. 4A shows an example of information that may be presented on display 440. As shown in FIG. 4A, display 440 may show a list of songs stored in memory 360 of mobile terminal 110. For example, the list of displayed songs may include “Stairway to Heaven,” “Rock and Roll All Nite,” and “Dancing Queen.” FIG. 4B shows another example of a mobile terminal's display 440. In this example, the lyrics “I wanna rock and roll all nite and party everyday!” may be displayed via display 440, in a timed text manner while simultaneously playing the song (“Rock and Roll All Nite”) through speaker 430. In implementations of the systems and methods, the downloaded timed text lyrics may be displayed to the user at the appropriate timing for singing along in a Karaoke application, for example.

Microphone 450 may include a device that converts speech or other acoustic signals into electrical signals for use by mobile terminal 110. Microphone 450 may be located anywhere on mobile terminal 110 and may be configured, for example, to convert spoken words or phrases into electrical signals for use by mobile terminal 110.

Audio input jack 470 may receive music via a jack connection from an external audio source. For example, music from a home stereo, computer, a portable CD player or AM/FM radio, or any other source of digital or analog music signals, may be received through audio input jack 470. Audio input jack 470 may be used in place of microphone 450 as an audio input device into mobile terminal 110. The music received through audio input jack 470 may be processed by a digital audio interface contained in user interface 330, for example.

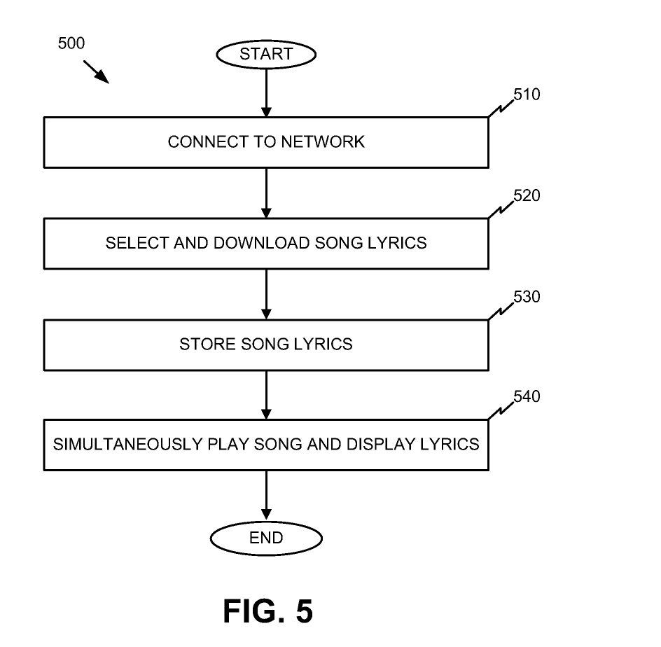

FIG. 5 illustrates exemplary processing 500 performed by mobile terminal 110. Processing may begin when a mobile terminal 110 powers up and connects to the network 140 (act 510). For example, using keys on keypad 410, a user may information to cause mobile terminal 110 to establish a data connection to server 150 via network 140. Once connected to server 150, a user of mobile terminal 110 may desire to download lyrics for a particular song from the server 150, via network 140. A user may select song lyrics to download from a displayed list of songs stored in mobile terminal 110, as shown in FIG. 4A. For example, a user may use control keys 420 to highlight and select a choice on the displayed list.

Once the desired song has been selected, the selected lyrics may be downloaded from server 150 (act 520). Selecting and downloading song lyrics (act 520), for example, may include a request that may be sent from mobile terminal 110 to server 150. The request may then be received by server 150, and the identified song lyrics, that may be stored in a timed text format, may be downloaded from server 150 to mobile terminal 110.

Once the lyrics have been downloaded to mobile terminal 110, the lyrics may then be stored (act 530). For example, downloaded lyrics in a timed text format, may be directly inserted into an audio file stored, for example, in an MPEG4/3GPP format. In other implementations, the downloaded lyrics may be stored separately from the song in memory 360. Once the lyrics are stored, the lyrics may then be simultaneously displayed in a timed text manner on display 440, while the song music may be played through speaker 130 (act 540). For example, as shown in FIG. 4B the lyrics “I wanna rock and roll all nite and party everyday!” may be displayed via display 440, while simultaneously playing the song (“Rock and Roll All Nite”) through speaker 430.

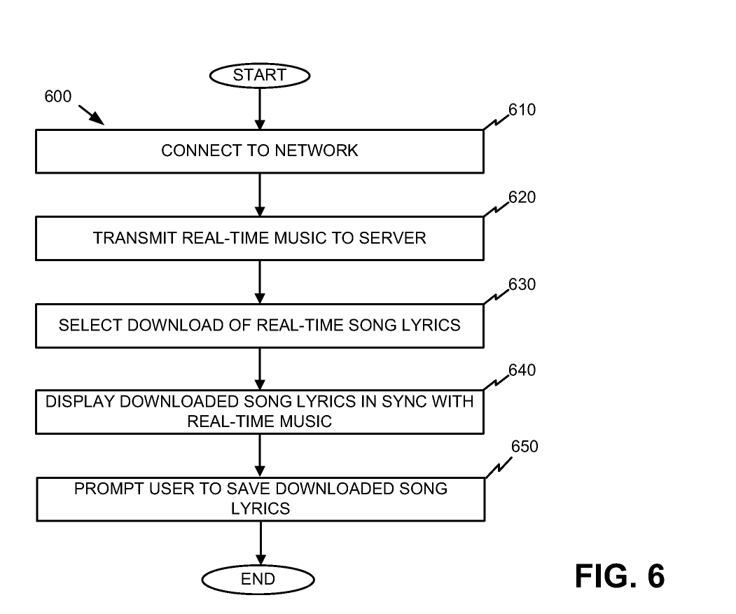

FIG. 6 illustrates another exemplary processing 600 performed by mobile terminal 110. Processing may begin when mobile terminal 110 powers up and connects to network 140 and server 150 (act 610). For example, using keys on keypad 410, a user may dial a phone number that may establish a connection from mobile terminal 110 to server 150. After mobile terminal 110 powers up and connects to server 150, a user may begin to transmit real-time music to server 150 (act 620). For example, real-time music may be background music at a cafe, live music at a concert, or may be music from an AM/FM radio. For example, a user may use microphone 450 in mobile terminal 110 to transmit the real-time music to server 150. In another implementation, real-time music received via audio input jack 470 may be transmitted to server 150 from mobile terminal 110 (act 620). In still further implementations, real-time music received and processed by an FM radio chip and a digital audio interface (contained in user interface 330) may also be transmitted from mobile terminal 110 to server 150 via network 140 (act 620). Server 150 may receive the real-time music and in song and lyrics database 290 using a known technique, identify the real-time music. Once the music is identified by server 150, server 150 may then begin to download the corresponding song lyrics to mobile terminal 110 (act 630).

In one implementation, server 150 may process the received real-time music from mobile terminal 110 to determine where to begin downloading lyrics based on a determined actual point in the real-time music. For example, server 150 may determine that the transmitted real-time music from mobile terminal 110 is currently at the point of the second verse of the lyrics in the song. Based on this determined point in the song, for example, server 150 may begin to download (e.g. stream) the lyrics substantially in sync with the real-time music. “Substantially in sync” as used herein, is intended to mean in sync or something less than in sync.

In another implementation, server 150 may download the entire song lyrics to mobile terminal 110, along with information relating to where to begin displaying the lyrics based on the determined point (e.g. second verse) or an anticipated future point in the real-time music.

In either implementation, display 440 in mobile terminal 110, may display the downloaded lyrics substantially in sync with the received real-time music (act 640). In these implementations for example, the downloaded lyrics may be transmitted to mobile terminal 110 in a timed text format or as text data.

As there may be minor transmission delays and processing delays in both server 150 and mobile terminal 110, displaying the downloaded lyrics substantially in synchronization with the real-time music may include displaying the downloaded lyrics on display 440 within a few seconds of the received song lyrics. For example, displaying the downloaded lyrics substantially in synchronization with the real-time music may include displaying the downloaded lyrics, via display 440, one or more seconds out-of-sync with the real-time music. In other implementations, server 150 and/or mobile terminal 110 may adjust the timing of the downloaded lyrics to compensate for transmission and processing delays. For example, server 150 may include downloaded information to mobile terminal 110 to display the downloaded lyrics one or more seconds before the determined actual point in the real-time music. Server 150 may also compensate for delays by downloading lyrics to mobile terminal 110 in an adjusted timing, for example, a timing that is one or more seconds before the determined point in the real-time music. Mobile terminal 110 may then display the downloaded lyrics before the lyrics may be heard in the real-time music, which may enhance the Karaoke features of mobile terminal 110, as the user may see the downloaded lyrics (and be ready to sing) before the lyrics are heard in the real-time music.

After the real-time music is finished, a user of mobile terminal 110 may be prompted to permanently save the downloaded lyrics (act 650). For example, the user may be automatically prompted to save the downloaded lyrics by a notification displayed via display 440 of mobile terminal 110. An exemplary prompt or query to the user may include a text display such as “Do you want to permanently save the lyrics?” or “Save lyrics to memory?” Using control keys 420, a user may choose or select whether to permanently store the downloaded lyrics in response to the prompt (act 650). If the user chooses to save the downloaded lyrics, the downloaded lyrics may be saved in, song and lyrics memory 360. In another implementation, the act (650) of prompting the user may be replaced with a default setting that automatically saves downloaded lyrics into memory 360.

In still further embodiments, as a user of mobile terminal 110 may not have the received real-time music song stored in memory 360, after real-time music is finished, server 150 may send a link to mobile terminal 110, for the purpose of purchasing the music with the lyrics inserted, for example. For example, a link may be displayed, via display 440, and a user may operate control keys 420 to use the link to access a server to purchase and download an audio file of the song that includes lyrics stored in a timed text format. The purchased song may then be downloaded and stored in song and lyrics memory 360 in mobile terminal 110.

Once the downloaded song lyrics have been stored in song and lyrics memory 360 in accordance with the implementations described in FIGS. 5-6, the downloaded song lyrics may be accessed at any time by the user of mobile terminal 110.

### Conclusion

Implementations consistent with the systems and methods described herein may allow users to download, store and display lyrics for Karaoke applications. This greatly enhances the capabilities of mobile terminals. In addition, these embodiments enable a user to download and store lyrics in a manner that requires little to no input by the user. This helps increase a user's satisfaction level with respect to Karaoke features of the mobile terminal.

The foregoing description of the embodiments provides illustration and description, but is not intended to be exhaustive or to limit implementations to the precise form disclosed. Modifications and variations are possible in light of the above teachings or may be acquired from practice of the implementations.

For example, the embodiments have been described in the context of a mobile terminal downloading lyrics from a network. In addition, the embodiments have been described as being implemented by mobile terminals connected to a communications network. The embodiments may be implemented in other devices or systems and/or networks.

Further, while series of acts have been described with respect to FIGS. 5-6, the order of the acts may be varied in other implementations. Moreover, non-dependent acts may be performed in parallel.

It will also be apparent to one of ordinary skill in the art that aspects of the implementations, as described above, may be implemented in cellular communication devices/systems, methods, and/or computer program products. Accordingly, the implementations may be embodied in hardware and/or in software (including firmware, resident software, micro-code, etc.). Furthermore, the implementations may take the form of a computer program product on a computer-usable or computer-readable storage medium having computer-usable or computer-readable program code embodied in the medium for use by or in connection with an instruction execution system. The actual software code or specialized control hardware used to implement aspects of the embodiments is not limiting of the systems and methods described. Thus, the operation and behavior of the aspects were described without reference to the specific software code—it being understood that one of ordinary skill in the art would be able to design software and control hardware to implement the aspects based on the description herein.

Further, certain portions of the embodiments may be implemented as “logic” that performs one or more functions. This logic may include hardware, such as a processor, a microprocessor, an application specific integrated circuit or a field programmable gate array, software, or a combination of hardware and software.

It should be emphasized that the term “comprises/comprising” when used in this specification is taken to specify the presence of stated features, integers, steps, or components, but does not preclude the presence or addition of one or more other features, integers, steps, components, or groups thereof.

No element, act, or instruction used in the description of the present application should be construed as critical or essential to the systems and methods described unless explicitly described as such. Also, as used herein, the article “a” is intended to include one or more items. Where only one item is intended, the term “one” or similar language is used. Further, the phrase “based on,” as used herein is intended to mean “based, at least in part, on” unless explicitly stated otherwise.

The scope of the systems and methods described herein are defined by the claims and their equivalents.

What is claimed is:

1. A method performed by a mobile terminal comprising:
selecting a song for which song lyrics are desired;
obtaining the song lyrics from a server;
storing the song lyrics in the mobile terminal; and
simultaneously playing the song while displaying the song lyrics on the mobile terminal.

2. The method of claim 1, wherein the storing the song lyrics further comprises:
associating and storing the song lyrics with the song.

3. The method of claim 2, wherein the associating and storing song lyrics with the song further comprises:
associating and storing the song lyrics in a timed text format with the song.

4. The method of claim 1, wherein the obtaining the song lyrics from a server includes downloading the song lyrics from the server.

5. The method of claim 1, wherein the selecting a song for which lyrics are desired includes selecting the song from a displayed list of songs stored in the mobile terminal.

6. A mobile terminal, comprising:
a speaker for outputting music;
a memory for storing audio files corresponding to a plurality of songs;
a display; and
logic configured to:
select a song for which song lyrics are desired;
obtain the song lyrics; and
associate and store in the memory the song lyrics with the song data stored in the memory.

7. The mobile terminal of claim 6, wherein the logic is further configured to:
control the display to simultaneously display the song lyrics while outputting the song music data through the speaker.

8. The mobile terminal of claim 6, wherein the song lyrics are in a timed text compatible format.

9. The mobile terminal of claim 6, wherein the logic is further configured to:
control the display to present a list of songs stored in the memory in the mobile terminal.

10. The mobile terminal of claim 6, wherein the song lyrics are downloaded from a network to the mobile terminal.

11. A method comprising:
receiving real-time music;
selecting to download song lyrics associated with the received real-time music;
downloading the selected song lyrics associated with the received real-time music to a mobile terminal; and
displaying the downloaded song lyrics associated with the received real-time music substantially in synchronization with the received real-time music.

12. The method of claim 11, wherein selecting to download song lyrics associated with the received real-time music further comprises:
transmitting the received real-time music to a server.

13. The method of claim 11, further comprising:
prompting a user to save the downloaded song lyrics associated with the received real-time music.

14. The method of claim 13, further comprising:
saving the downloaded song lyrics associated with the received real-time music in a memory in the mobile terminal.

15. The method of claim 12, wherein the server identifies a song associated with the transmitted real-time music.

16. A mobile terminal, comprising:
a display; and
logic configured to:
obtain song lyrics associated with real-time music; and
control the display to display the song lyrics substantially in synchronization with the real-time music.

17. The mobile terminal of claim 16, wherein the logic is further configured to:
prompt a user to save the song lyrics associated with the real-time music.

18. The mobile terminal of claim 16, further comprising:
a microphone for transmitting the real-time music to a server.

19. The mobile terminal of claim 18, wherein the server identifies a song associated with the real-time music.

20. The mobile terminal of claim 18, wherein the song lyrics associated with the real-time music are downloaded from the server.
